(19) United States
(12) Patent Application Publication
(10) Pub. No.: US 2006/0064829 A1
(43) Pub. Date: Mar. 30, 2006

(54) Pipeline pig

(76) Inventors: Peter Houldey, Chester-le-Street (GB); Peter Couchman, Gosforth (GB); Ian Smith, Morpeth (GB)

Correspondence Address: STITES & HARBISON PLLC, 1199 NORTH FAIRFAX STREET, SUITE 900, ALEXANDRIA, VA, 22314, US

(21) Appl. No.: 11/238,140

(22) Filed: Sep. 29, 2005

(30) Foreign Application Priority Data
Sep. 30, 2004 (GB) 0421769.1

(51) Int. Cl. B08B 9/055

(52) U.S. Cl. 15/104.061

(57) ABSTRACT

Vehicle parts of a pipeline pig are connected by a pivotable joint. The joint comprises first and second part-spherical hollow shells joined together, each shell having an aperture therein, said apertures being aligned, said first shell being mounted in a curved recess in said first vehicle part to the pivotable therein part, said second shell being mounted in a curved recess in said second vehicle part to the pivotable therein, the first and second vehicle parts each having ducts leading to the joint and communicating with said apertures and wherein pipeline pig harnessing passes between the vehicle parts through said ducts and said apertures.

### BACKGROUND OF THE INVENTION

1. Field of the Invention

The present invention relates to a pipeline pig, also known as an in-line pipeline inspection tool, which is configured to pass down the interior of a pipe to monitor the pipe. It also relates to a joint for use in interconnection vehicle parts of such a pipeline pig.

2. Summary of the Prior Art

It is now common to inspect a pipeline from the inside using a pipeline pig which passes down the pipeline. The pig carries sensors which can detect the properties of the pipe, changes in magnetic flux paths, irregularities, etc. and thus provide an indication of the presence and size of pipe defects. Pipeline pigs come in many configurations, but generally comprise one or more pig vehicle parts which are articulated together. The pig may be driven through the pipeline under its own power, or due to the pressure of product within the pipe. The interior of the pig may be pressured or be at atmospheric pressure.

Where a pipeline pig comprises a plurality of pig vehicle parts, it is often necessary to provide electrical, power data and/or pressure communication between the parts. Conventionally, that has been done by cables, ducts or other flexible connections (normally known as “harnessing”) which pass from one vehicle part to another. In order to do this, they must pass out of one vehicle part and extend to the other. Since the interior of the vehicle parts may often need to exclude pipeline pressure, hermetic connectors or waterproof connectors must be present where the harnessing emerges from the vehicle part. Such connectors are expensive and such an arrangement also has the disadvantage that the harnessing is exposed to the exterior of the pig, and therefore has an increased risk of damage.

FIGS. 1 and 2 of the accompanying drawings illustrate known pipeline pig configurations. In FIG. 1, the pig comprises a first vehicle 10 (the magnetic vehicle) and a second vehicle 12 (the instrument vehicle). These two vehicles 10, 12 are connected together by a connection 14 providing an articulated interconnection link between the two vehicles. The first vehicle 10 has a body 11, usually made of steel to provide a magnetic return path, which carries a plurality of magnet units 13 which impart a magnetic flux to the wall of the pipe. The magnet units 13 may carry bristles to ensure that appropriate magnetic contact is made. FIG. 1 also shows that the vehicle 10 has a ring of sensors 16 which detect internal and/or external conditions of, or defects in, the pipe. Pressure from the pipeline product is used to move the vehicle 10, and hence the pipeline pig along the pipe. The vehicle 10 has resilient seals 20 extending therefrom, which will abut against the internal surface of the pipe and act as a pressure surface for driving the pig through the pipe.

The second vehicle 12 has a ring of sensors 18 similar to the sensor ring 16, and has a body 19 forming a pressure vessel. That body 19 provides a flame proof and explosion proof environment for electrical equipment, which is maintained at e.g. atmospheric pressure, and sealed from the interior of the pipeline.

The vehicle 12 also has wheels 15 which, can bear against the inside wall of the pipe, when the pig is moving along the pipe, and cause the body 19 to be positioned on or near the centre axis of the pipe.

As mentioned, the connection 14 provides an articulated interconnection link between the two vehicles 10, 12 but, in addition to that connection, it is necessary to interconnect e.g. electrical components within the two vehicles 10, 12. Thus, harnessing 22 extends between the vehicles 10, 12 providing that interconnection. Hermetic seals 24 are provided at the junction of the harnessing and the casing of the vehicles 10, 12.

Similarly, FIG. 2 illustrates another known pipeline pig in which there are three vehicles 30, 32, 34, connected by respective connections 36, 38 to provide articulation between the vehicles 30, 32, 34. Harnessing 22 is again provided which interconnects the electronic components of the vehicles 30, 32, 34.

Some of the features of the vehicles 30, 32, 34 are the same as in the pipeline pig of FIG. 1, and are indicated by the same reference numerals. In this embodiment, the third vehicle 34 has two sets of wheels 40, 42, and similarly the second vehicle has two sets of wheels 44, 46. As in the pig of FIG. 1, the first vehicle 30, does not have wheels but the seal 20 bears against the wall of the pipe. Moreover, in this arrangement, the body 11 of the vehicle 30 will not accommodate a pressure vessel, and therefore much of the electronics of the pig needs to be contained within the other vehicles 32, 34. Thus, for example, the vehicle 32 may contain the instrumentation for recording data from the sensors 16, 18, etc whilst the vehicle 34 may contain a battery for powering the instrumentation.

Thus, in the pigs of FIGS. 1 and 2, the harnessing 22 is an external component. Moreover, the conventional connections 14, 36, 38 are relatively long, and make a significant contribution to the overall length of the pig.

### SUMMARY OF THE INVENTION

There is increasingly a need for shorter pipeline pigs, because such shorter pigs are more able to negotiate bends in the pipeline and better able to fit in the launch and receive traps at the ends of the pipeline. In addition, it becomes possible to have larger pig vehicles, or more pig vehicles, in the same overall length.

Therefore, at its most general, the present invention proposes that the vehicle parts of a pipeline pig may be interconnected by a pivotable joint, which is hollow, with a shell part of the joint having an aperture therein which provides a passageway through joint and thus can connect with ducts in the walls of the vehicle parts. This provides an interconnection through which harnessing can pass, isolated from pipeline product and pressure, while simultaneously providing the articulation of one vehicle part to another.

Thus, the present invention may provide a pipeline pig having first and second pig vehicle parts interconnected by a pivotable joint, wherein the joint comprises a part-spherical hollow shell connected to the first vehicle part, and a curved recess in the second vehicle part in which the shell is mounted to be pivotable in said recess in about its centre, the pig vehicle parts each having ducts leading to the joint and the shell having an aperture therein interconnecting the ducts, and wherein pipeline pig harnessing passes between the vehicle parts through the ducts and the aperture.

Hence, the present invention avoids the external harnessing of the known arrangements, and interconnects the interiors of the pig vehicles to enable the interior of two vehicle parts to be under a common pressure e.g. atmospheric pressure, and sealed from the interior of the pipe. The joint thus provides a path for the harnessing which is not exposed to the fluids or other product inside the pipe, thereby avoiding the need for hermetic connectors, etc. Moreover, the use of the shell and recess arrangements permit a more compact interconnection of the vehicle parts than in known arrangements.

Preferably, the recess is a slot into which the shell extends, so there is material on both sides of the shell. This provides a more robust arrangement if e.g. one surface or the other of the shell was wholly exposed. Seals may be provided between the shell the recess or slot walls, to seal the joint.

The recess may be provided in a flange mounted on the second vehicle part, or may be in part of the wall of the vehicle part itself.

In further development of the invention, the joint has two part-spherical hollow shells joined together, each with an aperture aligned with the other to provide a path between the shells. Each shell is then received in a respective recess. In such arrangements, one recess is in one vehicle part and the other recess is in the other. This arrangement is preferred because it provide a greater degree of articulation than the provision of a single shell/recess structure.

It is desirable for the mouths of the ducts to be flared at their ends nearest the aperture. The open mouths of the ducts may then conform to the range of movement of the aperture, so that the harnessing is not forced against a corner or other surface which could damage it.

The present invention has been described above in terms of a pipeline pig having pig vehicle parts interconnected by a pivotable joint. It also relates to a pivotable joint for use in such an interconnection. The joint thus may comprise a part-spherical hollow shell connected to an attachment body or attachment to a first vehicle part, and a curved recess in a second attachment body for connection to a second vehicle part, in which the shell is mounted to be pivotable in said recess about its centre. The attachment bodies each having ducts therein, and the shell having an aperture therein with the duct and the aperture in the shell in communication.

### BRIEF DESCRIPTION OF THE DRAWINGS

An embodiment of the present invention will now be described in detail, by way of example, with reference to the accompanying drawings, in which:

FIG. 1 shows one known pipeline pig, and has already been described;

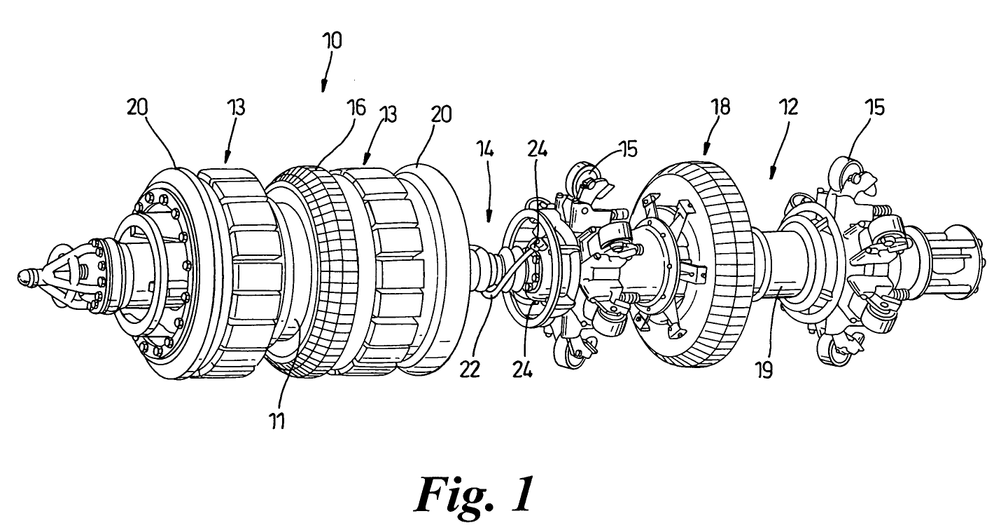

FIG. 2 shows a second known pipeline pig, and has already been described;

FIG. 3 is a schematic view of the pipeline pig incorporating the present invention;

FIGS. 4a and 4b are sectional and end views through a joint of the pig of the embodiment FIG. 3; and

FIGS. 5a and 5b are sectional views similar to FIGS. 4a and 4b but showing the joint in a different position.

### DETAILED DESCRIPTION

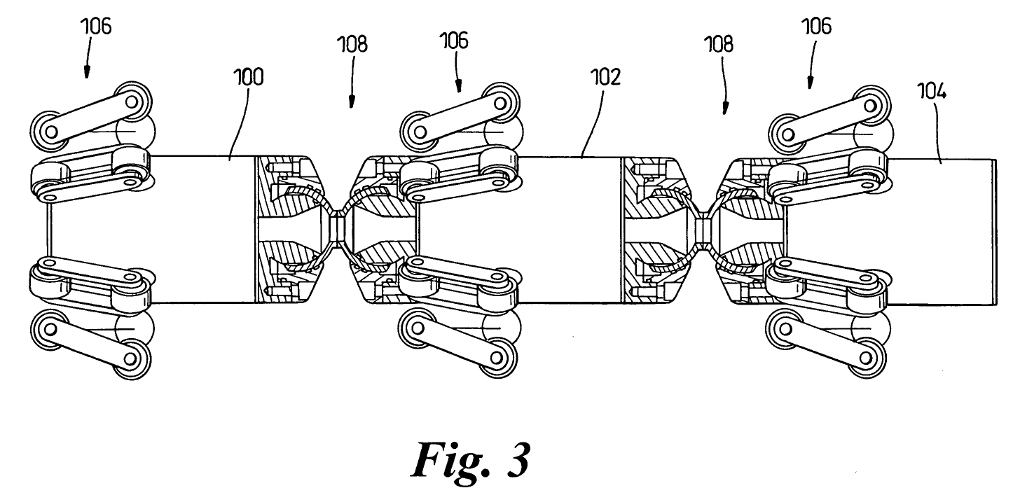

Referring first to FIG. 3, a pipeline pig includes at least three pig vehicles 100, 102, 104. Each of those vehicles 100, 102, 104 has wheels 106 which will abut against the interior of the pipe to guide the pig as the pig passes down the pipe. The internal structure of the vehicles 100, 102, 104 may be conventional, and is not discussed in further detail.

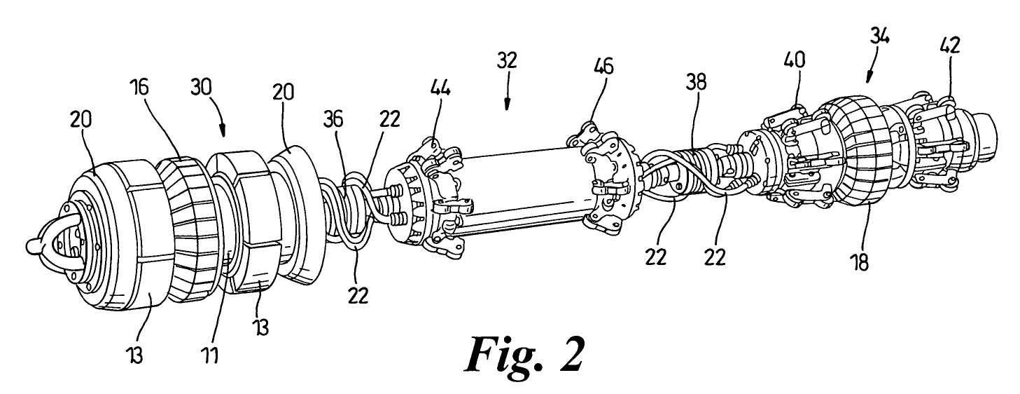

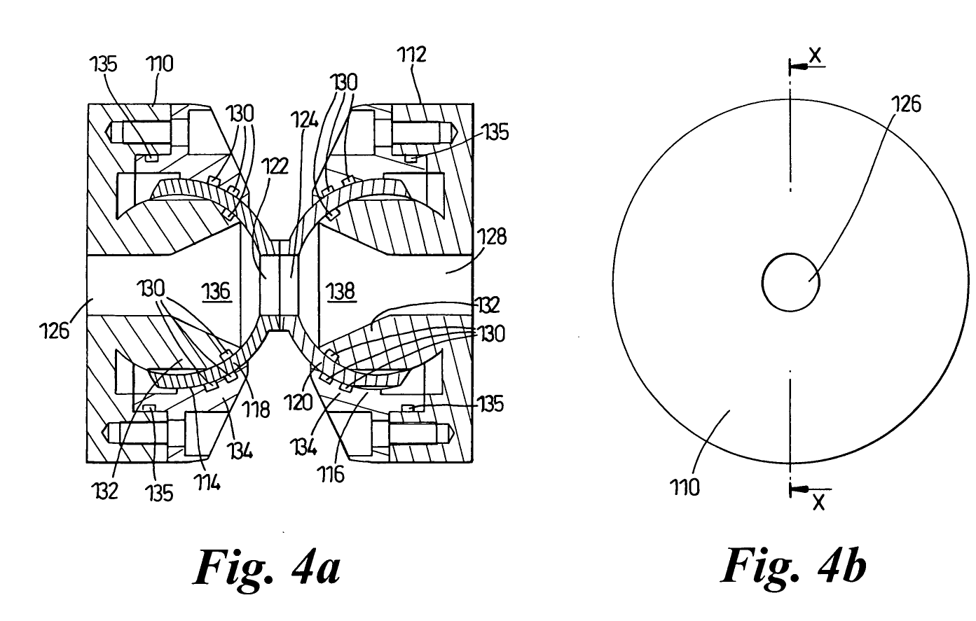

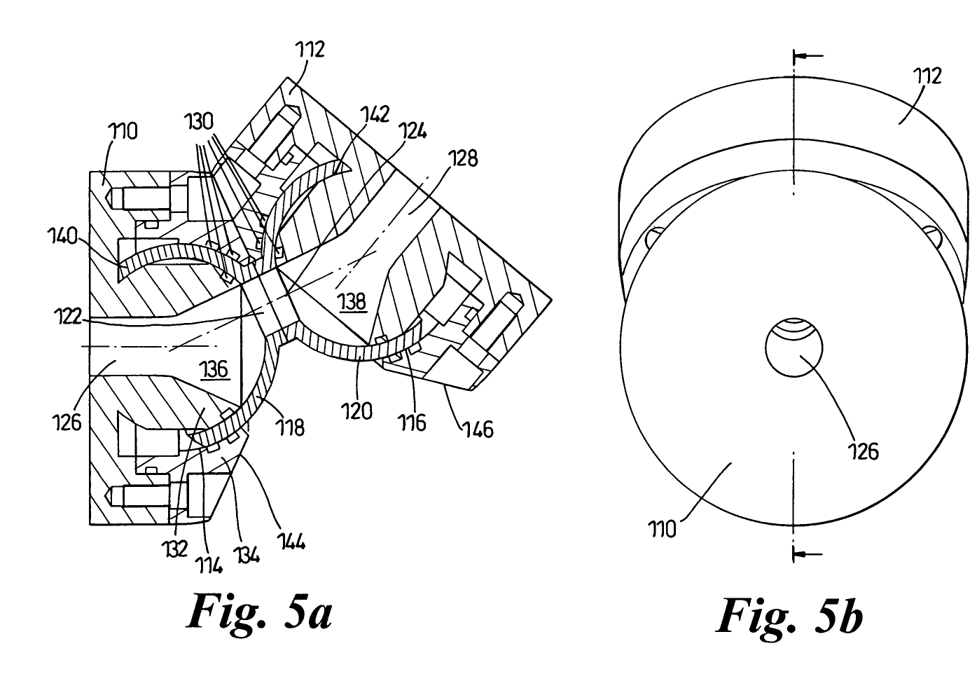

The vehicles 100, 102, 104 are interconnected by joints 108, which are illustrated in more detail in FIGS. 4 and 5. In fact, the vehicles 100, 102, 104 may conform to the vehicle 32 in FIG. 2, so that there is a further vehicle equivalent to the vehicle 30 in FIG. 2 ahead of the vehicle 100 in FIG. 3, and a vehicle equivalent to the vehicle 34 after the vehicle 104 in FIG. 3. Those additional vehicles may be joined to the vehicles 100, 104 by joints similar to the joints 108.

Thus, referring to FIG. 4, each joint has a first flange 110 connectable to one of the vehicles 100, 102, 104 and a second flange 112 connected to another of those vehicles. Each flange has a slot 114, 116 therein, the slots being shaped to conform to part of the surface of the sphere. The joint also has first and second shells 118, 120 which are joined together so that the shells open in opposite directions, and each shell 118, 120 extends into a respective one of the slots 114, 116. Shells 118, 120 are moveable in those slots. Moreover, each shell 118, 120 has an aperture 122, 124 therein, the apertures being aligned.

Each of the flanges 110, 112 has a duct 126, 128 therein so that a path is defined from one duct 126 to the other via the apertures 122, 124. This provides a path for harnessing from one vehicle to another.

As shown in FIG. 4a respective seals 130 are incorporated in parts 132, 134 of the flanges 110, 112 acting upon the shells 118, 120 to seal those components together. Thus, the interior of the vehicles 100, 102, 104 and hence the path defined by the ducts 126, 128 and apertures 122, 124 may be sealed in order to resist ingress of product from the pipeline into the pig through the joint.

FIG. 4a also shows that the slot 114 is defined between two projecting parts 132, 134 of the flange 110, so the shell 118 has parts of the flange on either side of it, so that it resists deformation. Note also that there is an annular seal 135 between the parts 132, 134 and the rest of the flange 110. The flange 112 has a similar configuration.

Moreover, FIG. 4a also shows that the ducts 126, 128 have flared mouths 136, 138.

The purpose of those flared mouths 136, 138 can be seen more clearly from FIG. 5a, which illustrate the joint of FIGS. 4a and 4b, but in an articulated arrangement. In FIGS. 5a and 5b, those parts which correspond to the parts in FIGS. 4a and 4b are indicated by the same reference numerals.

It can be seen that in FIG. 5, representing the joint at one limit of its range of movement, in which ends 140, 142 of the shells 118, 120 abut against the closed ends of the slots 114, 116, the apertures 122, 124 are still aligned with the mouths 136, 138 of the ducts 126, 128. Thus, even in such an extreme position, there is still a clear path between the vehicles. It can also be seen that the flanges 110, 112 have tapered surfaces 144, 146 to accommodate a range of movement illustrated in FIG. 5.

Thus, with the present invention, a joint is provided between vehicles of a pipeline pig which is both compact and provides a passageway for harnessing. The passageway may be sealed, so that the path of the harnessing does not emerge from an environment which is isolated from the internal pressure of the pipeline, and adaptors such hermetic seals are not required. The joint is compact, and therefore the overall length of the pig may be minimised.

1. A pipeline pig having first and second pig vehicle parts interconnected by a pivotable joint, wherein the joint comprises a part-spherical hollow shell connected to the first vehicle part, and a curved recess in the second vehicle part in which the shell is mounted to be pivotable in said recess in about its centre, the pig vehicle parts each having ducts leading to the joint and the shell having an aperture therein interconnecting the ducts, and wherein pipeline pig harnessing passes between the vehicle parts through the ducts and the aperture.

2. A pipeline pig according to claim 1, wherein said recess is a slot into which said shell extends.

3. A pipeline pig according to claim 1, wherein said recess is in a flange on said second vehicle part.

4. A pipeline pig according to claim 1 wherein there is a seal between the recess and the shell.

5. A pipeline pig according to claim 1 wherein there is a seal between each recess and the corresponding shell.

6. A pipeline pig according to claim 1, wherein at least one of said ducts have flared mouths.

7. A pipeline pig having first and second pig vehicle parts interconnected by a pivotable joint, wherein the joint comprises first and second partspherical hollow shells joined together, each shell having an aperture therein, said apertures being aligned, said first shell being mounted in a curved recess in said first vehicle part to the pivotable therein part, said second shell being mounted in a curved recess in said second vehicle part to the pivotable therein, the first and second vehicle parts each having ducts leading to the joint and communicating with said apertures, and wherein pipeline pig harnessing passes between the vehicle parts through said ducts and said apertures

8. A pipeline pig according to claim 7, wherein each of said recesses is a slot into which the corresponding shell extends.

9. A pipeline pig according to claim 8, wherein each of said recesses is in a flange on the corresponding vehicle part.

10. A pipeline pig according to claim 7, wherein there is a seal between each recess and the corresponding shell.

11. A pipeline pig according to claim 7, wherein at least one of said ducts has a flared mouth.

12. A joint for pivotally interconnecting pig vehicle parts, said joint comprising a part spherical hollow shell connected to an attachment body or attachment to a first vehicle part, and a curved recess in a second attachment body for connection to a second vehicle part, in which the shell is mounted to be pivotally in said recess about its centre, the attachment bodies each having ducts therein, and the shell having an aperture therein with the duct and the aperture in the shell in communication.
